(19) United States
(12) Patent Application Publication
(10) Pub. No.: US 2019/0005950 A1
(43) Pub. Date: Jan. 3, 2019

(54) INTENTION ESTIMATION DEVICE AND INTENTION ESTIMATION METHOD

(71) Applicant: MITSUBISHI ELECTRIC CORPORATION, Tokyo (JP)

(72) Inventors: Yi JING, Tokyo (JP); Jun ISHII, Tokyo (JP)

(73) Assignee: MITSUBISHI ELECTRIC CORPORATION, Tokyo (JP)

(21) Appl. No.: 16/063,914

(22) PCT Filed: Mar. 30, 2016
(86) PCT No.: PCT/JP2016/060413

§ 371 Date: Jun. 19, 2018

(51) Int. Cl. G10L 15/18; G10L 15/22; G06F 17/27

(52) U.S. Cl. CPC G10L 15/1822; G10L 15/22; G06F 17/271; G10L 2015/228; G06F 17/2755; G10L 2015/223; G06F 17/2715

(57) ABSTRACT

When among simple sentences which are estimation targets for an intention estimator, there is a simple sentence whose intention estimation has failed, a supplementary information estimator estimates supplementary information from the simple sentence by using a supplementary information estimation model stored in a supplementary information estimation model storage. When among the simple sentences which are the estimation targets for the intention estimator, there is a simple sentence from which an imperfect intention estimation result is provided, an intention supplementation unit supplements the imperfect intention estimation result by using the supplementary information estimated by the supplementary information estimator.

### TECHNICAL FIELD

The present invention relates to an intention estimation device for and an intention estimation method of recognizing a text which is inputted using voice, a keyboard, or the like, to estimate a user's intention, and performing an operation which the user intends to perform.

### BACKGROUND ART

In recent years, a technique for recognizing a human being's free utterance and performing an operation on a machine or the like by using a result of the recognition has been known. This technique is used as a voice interface for a mobile phone, a navigation device, and so on, to estimate an intention included in a recognition result of an inputted voice, and can respond to users' various phrases by using an intention estimation model which is learned from various sentence examples and corresponding intentions by using a statistical method.

Such a technique is effective for a case in which the number of intentions included in the contents of an utterance is one. However, when an utterance, such as a complex sentence, which includes plural intentions is inputted by a speaker, it is difficult to estimate the plural intentions correctly. For example, an utterance of “my stomach is empty, are there any stores nearby?” has two intentions: “my stomach is empty” and “search for nearby facilities”, and it is difficult to estimate these two intentions by simply using the above-mentioned intention estimation model.

To solve this problem, conventionally, for example, Patent Literature 1 proposes a method of, as to an utterance including plural intentions, estimating the positions of appropriate division points of an inputted text by using both intention estimation and the probability of division of a complex sentence.

### CITATION LIST

### Patent Literature

Patent Literature 1: Japanese Unexamined Patent Application Publication No. 2000-200273

### SUMMARY OF INVENTION

### Technical Problem

However, in the technique described in Patent Literature 1, a result of estimating plural intentions by using division points is simply outputted just as it is, and how to cope with a case where the estimation of an appropriate intention cannot be carried out is not provided. Thus, for example, in the above-mentioned example, the use of an intention estimation model which is generated from specific command utterances for car navigation, such as “destination setting” and “nearby facility search”, makes it possible to estimate an intention such as a search for nearby facilities. However, it is difficult to carryout intention estimation on a free utterance by use of the intention estimation model, such as “My stomach is empty”, which is not a command. Thus, not “search for nearby restaurants” which is a user's intention, but an intention “search for nearby stores” is finally estimated, and thus it cannot be said that the user's intention is estimated with a high degree of accuracy. Consequently, after that, the conventional technique simply serves as a typical interactive method of further inquiring of the user about the type of the stores, and estimating the user's intention finally. In contrast, in a case in which the method described in above-mentioned Patent Literature 1 is adapted also to free utterances such as “My stomach is empty”, a huge amount of learning data must be collected, and it is actually difficult to adapt the method to all free utterances.

The present invention is made in order to solve the above-mentioned problems, and it is therefore an object of the present invention to provide an intention estimation device and an intention estimation method capable of estimating a user's intention with a high degree of accuracy also for a complex sentence including plural intentions.

### Solution to Problem

An intention estimation device according to the present invention includes: a morphological analysis unit for carrying out a morphological analysis on a complex sentence including plural intentions; a syntactic analysis unit for carrying out a syntactic analysis on the complex sentence on which the morphological analysis is carried out by the morphological analysis unit, to divide the complex sentence into plural simple sentences; an intention estimation unit for estimating an intention included in each of the plural simple sentences; a supplementary information estimation unit for, when among the simple sentences which are estimation targets for the intention estimation unit, there is a simple sentence whose intention estimation has failed, estimating supplementary information from the simple sentence whose intention estimation has failed; and an intention supplementation unit for, when among the simple sentences which are the estimation targets for the intention estimation unit, there is a simple sentence from which an imperfect intention estimation result is provided, supplementing the imperfect intention estimation result by using the estimated supplementary information.

### Advantageous Effects of Invention

When among simple sentences which are estimation targets, there is a simple sentence whose intention estimation has failed, the intention estimation device according to the present invention estimates supplementary information from this sentence, and, when among the simple sentences which are the estimation targets, there is a simple sentence which is resulted in an imperfect intention estimation, supplements the imperfect intention estimation result by using the estimated supplementary information. As a result, a user's intention can also be estimated for a complex sentence including plural intentions with a high degree of accuracy.

### BRIEF DESCRIPTION OF DRAWINGS

FIG. 1 is a block diagram showing an intention estimation device according to Embodiment 1;

FIG. 2 is an explanatory drawing showing an example of an intention estimation model according to Embodiment 1;

FIG. 3 is an explanatory drawing showing an example of a supplementary information estimation model according to Embodiment 1;

FIG. 4 is a block diagram showing an example of the hardware configuration of the intention estimation device according to Embodiment 1;

FIG. 5 is a block diagram showing an example of a configuration for explaining a process of generating the supplementary information estimation model according to Embodiment 1;

FIG. 6 is an explanatory drawing showing an example of learning data for the supplementary information estimation model according to Embodiment 1;

FIG. 7 is a flow chart for explaining processing for generating the supplementary information estimation model according to Embodiment 1;

FIG. 8 is an explanatory drawing showing an example of interaction according to Embodiment 1;

FIG. 9 is a flow chart for explaining intention supplementation processing according to Embodiment 1;

FIG. 10 is an explanatory drawing showing the score of each feature quantity for each supplementary information according to Embodiment 1;

FIG. 11 is a diagram showing a computation expression according to Embodiment 1, for calculating the product of scores;

FIG. 12 is an explanatory drawing showing a final score for each supplementary information according to Embodiment 1;

FIG. 13 is a flowchart showing a flow of the intention supplementation processing according to Embodiment 1;

FIG. 14 is a block diagram of an intention estimation device according to Embodiment 2;

FIG. 15 is an explanatory drawing showing an example of a supplementary intention estimation model according to Embodiment 2;

FIG. 16 is a block diagram showing an example of a configuration for explaining processing for generating the supplementary intention estimation model according to Embodiment 2;

FIG. 17 is an explanatory drawing showing an example of learning data for the supplementary intention estimation model according to Embodiment 2;

FIG. 18 is a flowchart for explaining the processing for generating the supplementary intention estimation model according to Embodiment 2;

FIG. 19 is an explanatory drawing showing an example of interaction according to Embodiment 2;

FIG. 20 is a flow chart for explaining supplementary intention estimation processing according to Embodiment 2; and

FIG. 21 is an explanatory drawing showing a final score for each supplementary intention according to Embodiment 2.

### DESCRIPTION OF EMBODIMENTS

Hereafter, in order to explain this invention in greater detail, embodiments of the present invention will be described with reference to the accompanying drawings.

### Embodiment 1

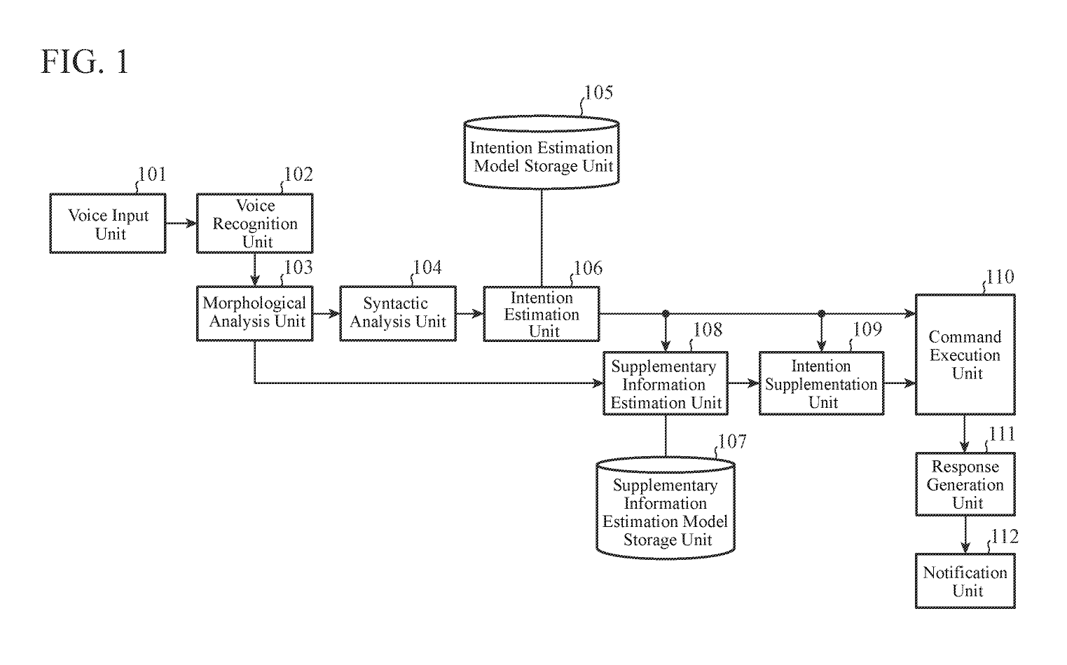

FIG. 1 is a block diagram of an intention estimation device according to the present embodiment.

As illustrated in the figure, the intention estimation device according to Embodiment 1 includes a voice input unit 101, a voice recognition unit 102, a morphological analysis unit 103, a syntactic analysis unit 104, an intention estimation model storage unit 105, an intention estimation unit 106, a supplementary information estimation model storage unit 107, a supplementary information estimation unit 108, an intention supplementation unit 109, a command execution unit 110, a response generation unit 111, and a notification unit 112.

The voice input unit 101 is an input unit of the intention estimation device, for receiving an input of voice. The voice recognition unit 102 is a processing unit that carries out voice recognition on voice data corresponding to the voice inputted to the voice input unit 101, then converts the voice data into text data, and outputs this text data to the morphological analysis unit 103. It is assumed in the following explanation that the text data is a complex sentence including plural intentions. A complex sentence consists of plural simple sentences, and one intention is included in one simple sentence.

The morphological analysis unit 103 is a processing unit that carries out a morphological analysis on the text data after conversion by the voice recognition unit 102, and outputs a result of the analysis to the syntactic analysis unit 104. Here, the morphological analysis is a natural language processing technique for dividing a text into morphemes (minimum units each having a meaning in language), and providing each of the morphemes with a part of speech by using a dictionary. For example, a simple sentence “Tokyo Tower e iku (Go to Tokyo Tower)” is divided into morphemes: “Tokyo Tower/proper noun, e/case particle, and iku/verb.”

The syntactic analysis unit 104 is a processing unit that carries out an analysis (syntactic analysis) on the text data on which the morphological analysis on a sentence structure is carried out by the morphological analysis unit 103, in units of a phrase or clause, in accordance with a grammatical rule. When the text corresponding to the text data is a complex sentence including plural intentions, the syntactic analysis unit 104 divides the complex sentence into plural simple sentences, and outputs a morphological analysis result of each of the simple sentences to the intention estimation unit 106. As a syntactic analysis method, for example, a CYK (Cocke-Younger-Kasami) method or the like can be used.

Although an explanation will be made hereafter by assuming that the text (complex sentence) includes two simple sentences 1 and 2, this embodiment is not limited to this example and the text can include three or more simple sentences. The syntactic analysis unit 104 does not have to output the data corresponding to all the divided simple sentences to the intention estimation unit 106. For example, even when the inputted text (complex sentence) includes a simple sentence 1, a simple sentence 2, and a simple sentence 3, only the simple sentence 1 and the simple sentence 2 can be set as an output target.

The intention estimation model storage unit 105 stores an intention estimation model used for carrying out intention estimation while defining morphemes as features. An intention can be expressed in such a form as “<main intention>[<slot name>=<slot value>, . . . ].” In this form, the main intention shows a category or function of the intention. As an example of a navigation device, the main intention corresponds to a machine command in an upper layer (a destination setting, listening to music, or the like) which a user operates first. The slot name and the slot value show pieces of information required to realize the main intention. For example, an intention included in a simple sentence “Chikaku no resutoran wo kensaku suru (Search for nearby restaurants)” can be expressed by “nearby facility search [facility type=restaurant]”, and an intention included in a simple sentence “Chikaku no mise wo kensaku shitai (I want to search for nearby stores)” can be expressed by “nearby facility search [facility type=NULL].” In the latter case, although a nearby facility search is carried out, it is necessary to further inquire of the user about a facility type because a concrete facility type is not determined. In the aforementioned case in which the slot has no concrete value, the intention estimation result is assumed to be an insufficient or imperfect result in this embodiment. Note that a case in which an intention cannot be estimated or the intention estimation fails means a state in which a main intention cannot be estimated.

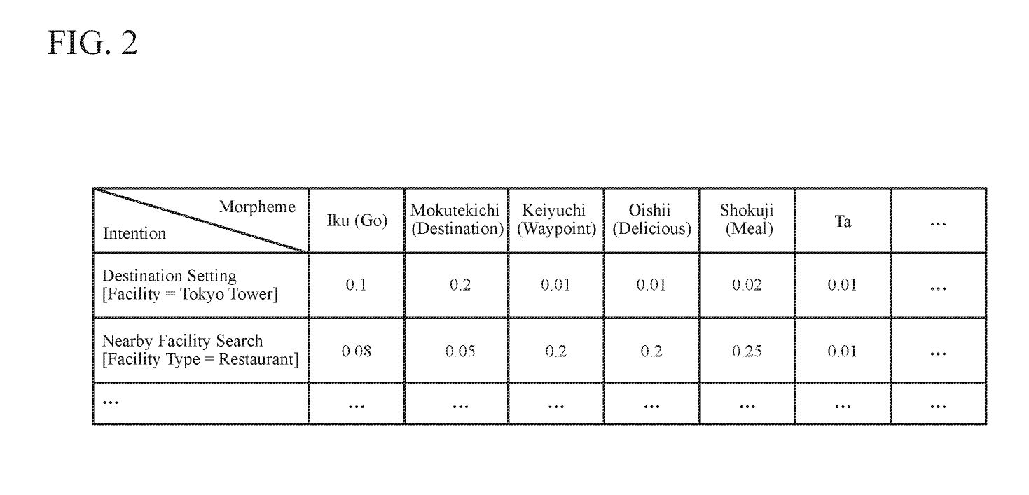

FIG. 2 is a diagram showing an example of the intention estimation model according to Embodiment 1. As shown in FIG. 2, the intention estimation model shows the score of each morpheme for each of intentions: “destination setting [facility=Tokyo Tower]”, “nearby facility search [facility type=restaurant]”, and so on. Because, as to each of morphemes: “iku (go)” and “mokutekichi (destination)”, there is a high possibility that the morpheme shows an intention of making a destination setting, the score of the intention “destination setting [facility=Tokyo Tower]” is high, as shown in FIG. 2. On the other hand, because, as to each of morphemes: “oishii (delicious)” and “shokuji (meal)”, there is a high possibility that the morpheme shows an intention of searching for nearby restaurants, the score of the intention “nearby facility search [facility type=restaurant]” is high. In the intention estimation model, intentions (not illustrated in FIG. 2) in which no concrete facility type is determined, such as “nearby facility search [facility type=NULL]”, are also included.

The intention estimation unit 106 is a processing unit that estimates an intention included in each of plural simple sentences on the basis of results of the morphological analysis carried out on the plural simple sentences, the results being inputted from the syntactic analysis unit 104, by using the intention estimation model, and is configured so as to output the results to the supplementary information estimation unit 108, the intention supplementation unit 109, and the command execution unit 110. Here, as an intention estimation method, for example, a maximum entropy method can be used. More specifically, the intention estimation unit 106 uses a statistical method, to estimate how much the likelihood of an intention corresponding to a morpheme inputted thereto increases, on the basis of a large number of sets which have been collected in advance, each set having a morpheme and an intention.

The supplementary information estimation model storage unit 107 stores a supplementary information estimation model showing a relation between simple sentences and pieces of supplementary information. More specifically, this supplementary information estimation model is supplementary information for performing the estimation of supplementary information from the morphemes of a simple sentence whose intention estimation has failed. Each supplementary information can be expressed in such a form as “<slot name>=<slot value>.”

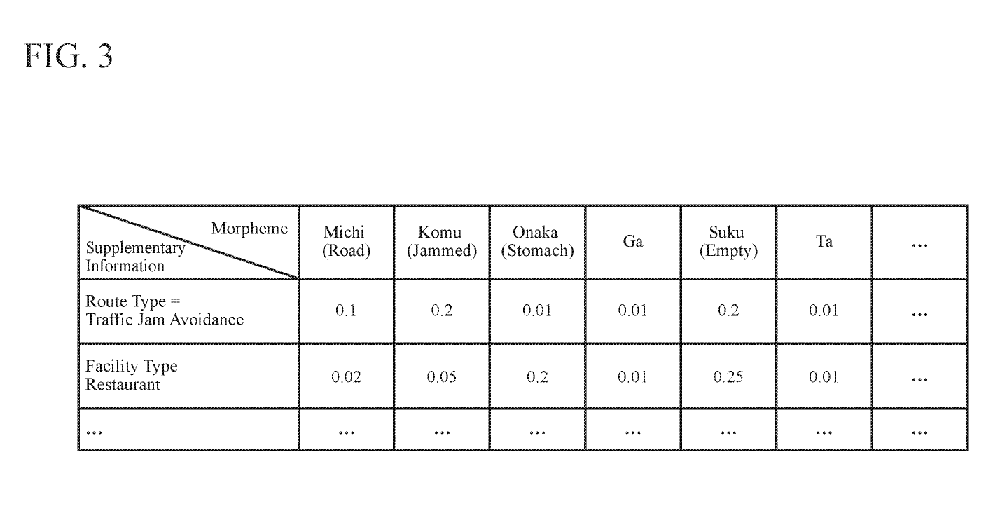

FIG. 3 is a diagram showing an example of the supplementary information estimation model according to Embodiment 1. As shown in FIG. 3, the model shows a relation between the morphemes of simple sentences, each of whose intentions cannot be estimated, and pieces of supplementary information (slot contents), with the morphemes as feature quantities. In FIG. 3, the score of each of the morphemes for each of the pieces of supplementary information: “route type=traffic jam avoidance”, “facility type=restaurant”, and so on is shown as an example. As shown in FIG. 3, because, as to each of morphemes: “michi (road)” and “komu (jammed)”, there is a high possibility that the morpheme has an intention of avoiding a traffic jam, the score of the supplementary information “route type=traffic jam avoidance” is high. On the other hand, because, as to each of morphemes: “onaka (stomach)” and “suku (empty)”, there is a high possibility that a slot showing an intention of wanting to have a meal is estimated, the score of the supplementary information “facility type=restaurant” is high.

The supplementary information estimation unit 108 is a processing unit that, as to a simple sentence whose intention estimation is insufficiently performed, refers to the supplementary information estimation model stored in the supplementary information estimation model storage unit 107 by using the morphemes of a simple sentence whose intention estimation has failed, to estimate supplementary information. For example, when a text “Onaka ga suita, syuuhen no mise wo sagasu (My stomach is empty; search for nearby stores)” is inputted, because the intention estimation for the simple sentence 2 is insufficient, supplementary information is estimated from the morphemes “onaka, ga, suku, and ta” of the simple sentence 1 “Onaka ga suita (My stomach is empty).” As a result, the supplementary information “facility type=restaurant” can be estimated. The estimated supplementary information is outputted to the intention supplementation unit 109. The details of an estimation algorithm will be mentioned later.

Although in the explanation, an example in which all the morphemes of a simple sentence whose intention estimation has failed are used for the estimation of supplementary information is shown, this embodiment is not limited to this example. For example, a clear rule such as a rule “to use morphemes other than Japanese particles” can be determined to select feature quantities, or only morphemes that are highly effective for the estimation of supplementary information can be used by using a statistical method.

The intention supplementation unit 109 is a processing unit that supplements the intention by using both the supplementary information acquired from the supplementary information estimation unit 108, and an intention whose intention estimation is insufficient (an intention in a state without a slot value). For example, when the supplementary information [facility type=restaurant] is acquired for the intention “nearby facility search [facility type=NULL]”, because their slot names are “facility type” and match each other, the slot name “facility type” is filled with the slot value “restaurant” and the intention “nearby facility search [facility type=restaurant]” is acquired. The supplemented intention is sent to the command execution unit 110.

The command execution unit 110 is a processing unit that executes a machine command (operation) corresponding to an intention included in each of plural simple sentences on the basis of the intention included in each of the plural simple sentences, the intention being estimated by the intention estimation unit 106, and an intention which is supplemented by the intention supplementation unit 109. For example, when an utterance of “Onaka ga suita, mise wo sagashite (My stomach is empty; search for stores)” is provided, an operation of searching for nearby restaurants is performed in accordance with the intention “nearby facility search “facility type=[restaurant]”.”

The response generation unit 111 is a processing unit that generates a response corresponding to the machine command executed by the command execution unit 110. The response can be generated in the form of text data, or a synthetic voice showing the response can be generated as voice data. When voice data is generated, for example, a synthetic voice such as “Nearby restaurants have been found. Please select one from the list.” can be provided.

The notification unit 112 is a processing unit that notifies a user, such as the driver of a vehicle, of the response generated by the response generation unit 111. More specifically, the notification unit 112 has a function of notifying a user that plural machine commands have been executed by the command execution unit 110. Any type of notification, such as a notification using a display, a notification using voice, or a notification using vibration, can be provided as long as the user can recognize the notification.

Next, the hardware configuration of the intention estimation device will be explained.

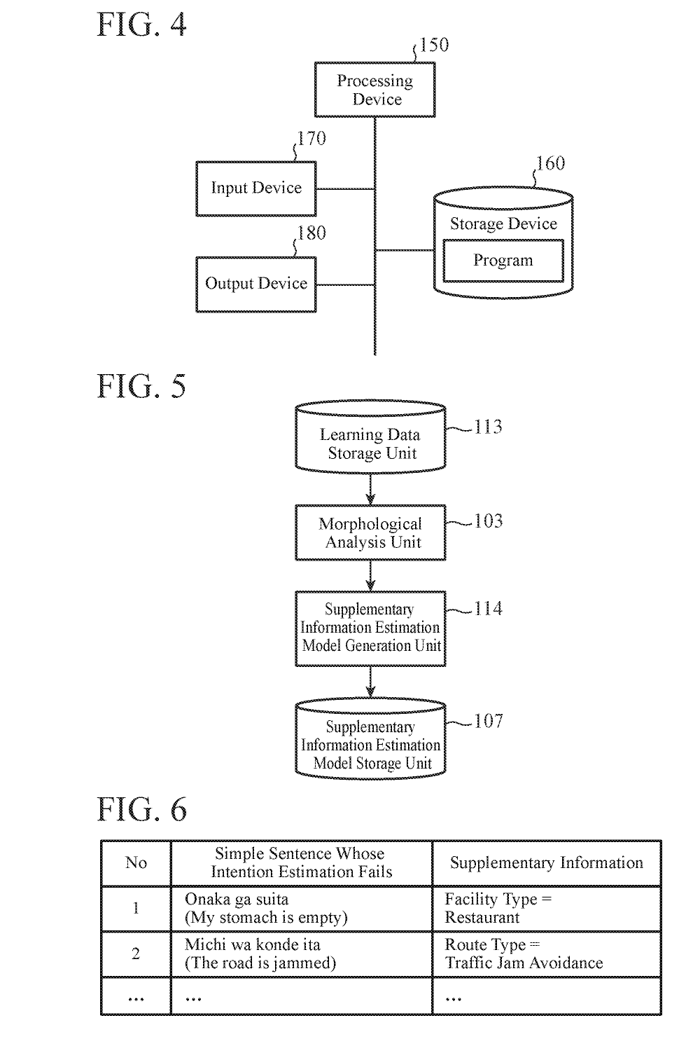

FIG. 4 is a diagram showing an example of the hardware configuration of the intention estimation device according to Embodiment 1. The intention estimation device is configured in such a way that a processing unit (processor) 150 such as a CPU (Central Processing Unit), a storage device (memory) 160 such as a ROM (Read Only Memory) or a hard disk drive, an input device 170 such as a keyboard or a microphone, and an output device 180 such as a speaker or a display are connected via a bus. The CPU can include a memory.

The voice input unit 101 shown in FIG. 1 is implemented by the input device 170, and the notification unit 112 is implemented by the output device 180.

Data stored in the intention estimation model storage unit 105, data stored in the supplementary information estimation model storage unit 107, data stored in a learning data storage unit 113 which will be mentioned later, and so on are stored in the storage device 160. Further, the “ . . . units” including the voice recognition unit 102, the morphological analysis unit 103, the syntactic analysis unit 104, the intention estimation unit 106, the supplementary information estimation unit 108, the intention supplementation unit 109, the command execution unit 110, and the response generation unit 111 are stored, as programs, in the storage device 160.

The processing unit 150 implements the function of each of the above-mentioned “ . . . units” by reading a program stored in the storage device 160 and executing the program as needed. More specifically, the function of each of the above-mentioned “ . . . units” is implemented by combining hardware which is the processing unit 150 and software which is the above-mentioned program. Further, although in the example of FIG. 4 the configuration in which the functions are implemented by the single processing unit 150 is shown, the functions can be implemented using plural processing units by, for example, causing a processing unit disposed in an external server to perform a part of the functions. More specifically, the processing unit 150 is an embodiment of a concept including not only one that the processing unit 150 consists of a single processing unit, but also one that the processing unit 150 includes plural processing units. Each of the functions of those “ . . . units” is not limited to the one implemented using a combination of hardware and software. As an alternative, by implementing the above-mentioned program on the processing unit 150, each of the functions can be implemented using only hardware such as a so-called system LSI. An embodiment of a generic concept including both the above-mentioned implementation using a combination of hardware and software, and the implementation using only hardware can be expressed as processing circuitry.

Next, the operation of the intention estimation device according to Embodiment 1 will be explained. First, processing for generating a supplementary information estimation model which is to be stored in the supplementary information estimation model storage unit 107 will be explained.

FIG. 5 is an explanatory drawing of an example of a configuration for performing the processing for generating a supplementary information estimation model according to Embodiment 1. In FIG. 5, the learning data storage unit 113 stores learning data in which plural pieces of supplementary information are associated with plural sentence examples.

FIG. 6 is an explanatory drawing showing an example of the learning data according to Embodiment 1. As shown in FIG. 6, the learning data are data in which supplementary information is provided for each of sentence examples of simple sentences whose intention estimation has failed. For example, supplementary information “facility type=restaurant” is provided fora sentence example No.1 “Onaka ga suita (My stomach is empty).” This supplementary information is manually provided in advance.

Returning to FIG. 5, the supplementary information estimation model generation unit 114 is a processing unit for learning the correspondence of pieces of supplementary information, the correspondence being stored in the learning data storage unit 113, by using a statistical method. The supplementary information estimation model generation unit 114 generates a supplementary information estimation model by using morphemes extracted by the morphological analysis unit 103.

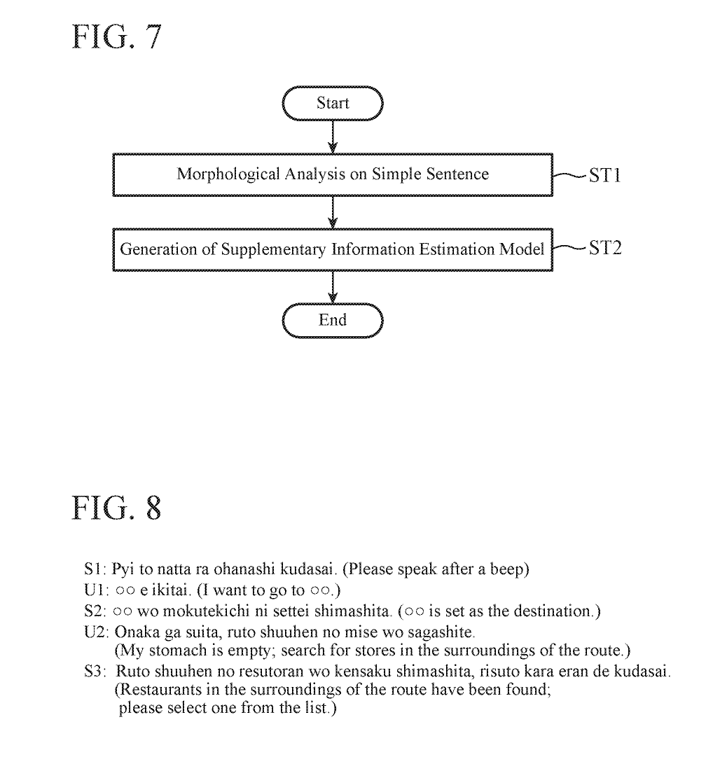

FIG. 7 is a flow chart for explaining the processing for generating a supplementary information estimation model according to Embodiment 1. First, the morphological analysis unit 103 carries out a morphological analysis on each of the sentence examples of the learning data stored in the learning data storage unit 113 (step ST1). For example, as to the sentence example No.1, the morphological analysis unit 103 carries out a morphological analysis on “Onaka ga suita (My stomach is empty).” The morphological analysis unit 103 outputs a result of carrying out the morphological analysis to the supplementary information estimation model generation unit 114.

The supplementary information estimation model generation unit 114 uses the morphemes provided through the analysis by the morphological analysis unit 103, to generate a supplementary information estimation model on the basis of the pieces of supplementary information included in the learning data (step ST2). For example, when morphemes “onaka (stomach)” and “suku (empty)” are provided, the supplementary information estimation model generation unit 114 determines that their scores are high because the corresponding supplementary information included in the learning data is “facility type=restaurant”, as shown in FIG. 6. The supplementary information estimation model generation unit 114 performs the same processing as the above-mentioned processing on all the sentence examples included in the learning data, to finally generate a supplementary information estimation model as shown in FIG. 3.

Next, an operation associated with intention supplementation processing using the supplementary information estimation model will be explained.

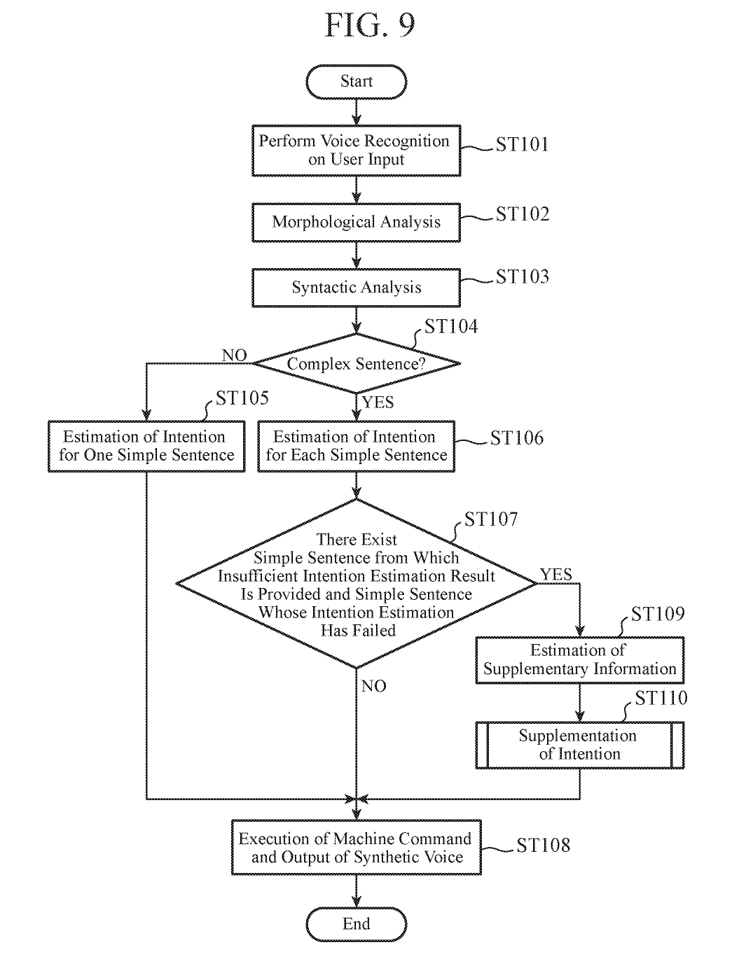

FIG. 8 is a diagram showing an example of interaction according to Embodiment 1. FIG. 9 is a flow chart for explaining the intention supplementation processing according to Embodiment 1.

First, as shown in FIG. 8, the notification unit 112 of the intention estimation device utters “Pyi to natta ra ohanashi kudasai. (Please speak after a beep.)” (S1). In response to this utterance, a user utters “∘∘ e ikitai. (I want to go to ∘∘.)” (U1). In this example, an utterance provided by the intention estimation device is expressed as “S”, and an utterance provided by the user is expressed as “U.” Numbers following U and S indicates the order of respective utterances.

In FIG. 9, when the user utters as shown in U1, the voice recognition unit 102 performs the voice recognition process on the user input (step ST101), to convert the user input into text data. The morphological analysis unit 103 performs the morphological analysis process on the text data after conversion (step ST102). The syntactic analysis unit 104 performs the syntactic analysis process on the text data on which the morphological analysis is performed (step ST103), and, when the text data is a complex sentence, divides the complex sentence into plural simple sentences. When the text data is not a complex sentence (NO in step ST104), the sequence shifts to processes of step ST105 and subsequent steps, whereas when the text data is a complex sentence (YES in step ST104), the sequence shifts to processes of step ST106 and subsequent steps.

Because the input example shown in U1 is a simple sentence, a result of the determination in step ST104 is “NO” and the sequence shifts to step ST105. Therefore, the syntactic analysis unit 104 outputs the text data about the simple sentence on which the morphological analysis is performed to the intention estimation unit 106. The intention estimation unit 106 performs the intention estimation process on the simple sentence inputted thereto, by using the intention estimation model (step ST105). In this example, an intention such as “destination setting [facility=α∘]” is estimated.

The command execution unit 110 executes a machine command corresponding to the intention estimation result provided by the intention estimation unit 106 (step ST108). For example, the command execution unit 110 performs an operation of setting the facility ∘∘ as a destination. Simultaneously, the response generation unit 111 generates a synthetic voice corresponding to the machine command executed by the command execution unit 110. For example, “∘∘ wo mokutekichi ni settei shimashita. (∘∘ is set as the destination.)” is generated as the synthetic voice. The notification unit 112 notifies the user of the synthetic voice generated by the response generation unit 111 by using the speaker or the like (step ST106). As a result, as shown in “S2” of FIG. 8, a notification such as “∘∘ wo mokutekichi ni settei shimashita. (∘∘ is set as the destination.)” is provided for the user.

Next, a case in which the user utters “Onaka ga suita, ruto shuuhen no mise wo sagashite. (My stomach is empty; search for stores in the surroundings of the route.)”, as shown in “U2” of FIG. 8, will be explained.

When the user utters as shown in “U2”, the voice recognition unit 102 performs the voice recognition process on the user input, to convert the user input into text data, and the morphological analysis unit 103 performs the morphological analysis process on the text data, as shown in FIG. 9 (steps ST101 and ST102). Next, the syntactic analysis unit 104 performs the syntactic analysis process on the text data (step ST103). At this time, the text data corresponding to the user input is divided into plural simple sentences such as a simple sentence 1 “Onaka ga suita (My stomach is empty)” and a simple sentence 2 “Ruto shuuhen no mise wo sagashite (Search for stores in the surroundings of the route).” Therefore, a result of the determination in step ST104 is “YES” and the sequence shifts to the processes of step ST106 and subsequent steps.

The intention estimation unit 106 performs the intention estimation process on each of the simple sentences 1 and 2 by using the intention estimation model (step ST106). In this example, the intention estimation unit 106 acquires, for the simple sentence 1, an intention estimation result showing that an intention has been unable to be estimated, and also acquires, for the simple sentence 2, an intention estimation result “nearby facility search [facility type=NULL].” More specifically, it is determined that the simple sentence 1 is in a state in which a main intention cannot be estimated, and that there is a strong likelihood that the simple sentence 2 shows “nearby facility search [facility type=NULL].”

When the intention estimation results provided by the intention estimation unit 106 include, as intention estimation results provided for a complex sentence, both an insufficient intention estimation result and a result showing that an intention has been unable to be estimated (YES in step ST107), the sequence shifts to processes of step ST109 and subsequent steps; otherwise (NO in step ST107), the sequence shifts to a process of step ST108.

Because both the result showing that the intention estimation has failed in the simple sentence 1 and the imperfect intention estimation result “nearby facility search [facility type=NULL]” provided for the simple sentence 2 are acquired from the intention estimation unit 106, the sequence then shifts to step ST109. Therefore, a result of the morphological analysis of the simple sentence 1 is sent to the supplementary information estimation unit 108, and supplementary information estimation is carried out (step ST109). Hereafter, the details of the supplementary information estimation process will be explained.

First, the supplementary information estimation unit 108 compares the morphemes of the simple sentence 1 with the supplementary information estimation model, to determine the score of each of the morphemes for each supplementary information.

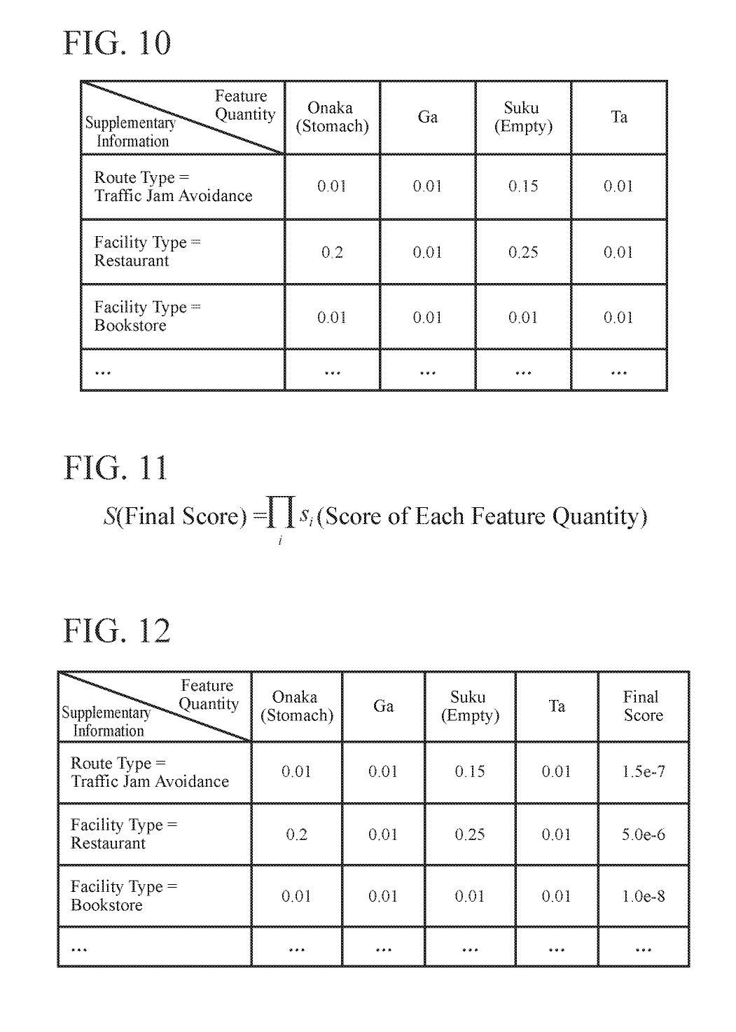

FIG. 10 is a diagram showing the score of each of morphemes for each supplementary information according to Embodiment 1. As shown in FIG. 10, for the supplementary information “route type=traffic jam avoidance”, a score of a feature quantity “onaka (stomach)” is determined as 0.01, a score of a feature quantity “ga” is determined as 0.01, a score of a feature quantity “suku (empty)” is determined as 0.15, and a score of a feature quantity “ta” is determined as 0.01. Also for any other supplementary information, the score of each of the feature quantities is determined in the same way.

FIG. 11 is a diagram showing a computation expression according to Embodiment 1, for calculating the product of scores. In FIG. 11, Si is the score of an i-th morpheme for supplementary information which is an estimation target. S is a final score showing the product of the scores Si for the supplementary information which is an estimation target.

FIG. 12 is a diagram showing the final score for each supplementary information according to Embodiment 1. The supplementary information estimation unit 108 calculates the final score shown in FIG. 12 by using the computation expression shown in FIG. 11. In this example, because, for the supplementary information “route type=traffic jam avoidance”, a score of the feature quantity “onaka (stomach)” is 0.01, a score of the feature quantity “ga” is 0.01, a score of the feature quantity “suku (empty)” is 0.15, and a score of the feature quantity “ta” is 0.01, the final score S which is the product of these scores is calculated as 1.5e-7. Also for any other supplementary information, the final score is calculated in the same way.

The supplementary information estimation unit 108 estimates, as appropriate supplementary information, the supplementary information “facility type=restaurant” having the highest score among the final scores calculated for respective pieces of supplementary information, each of which is an estimation target. More specifically, the supplementary information estimation unit 108 estimates supplementary information on the basis of the scores of plural morphemes, the scores being included in the supplementary information estimation model. In addition, supplementary information is estimated on the basis of the final scores each of which is acquired by calculating the product of the scores of plural morphemes. The estimated supplementary information “facility type=restaurant” is sent to the intention supplementation unit 109. As the method of estimating supplementary information, instead of the method of using the product of the scores of plural morphemes, for example, a method of calculating the sum of the scores of plural morphemes and selecting supplementary information having the highest value (final score) can be used.

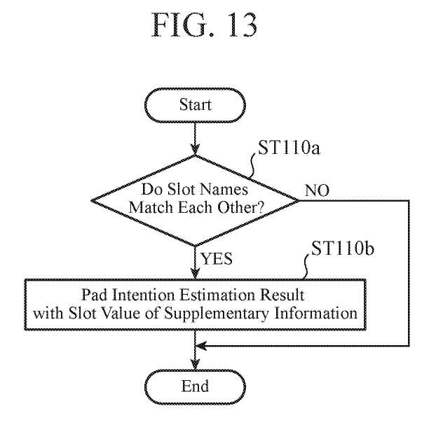

Returning to FIG. 9, the intention supplementation unit 109 performs processing for supplementing an intention by using the result estimated by the supplementary information estimation unit 108 (step ST110). A flow of the intention supplementation processing is shown in FIG. 13. More specifically, the intention supplementation unit 109 uses “facility type=restaurant” which is the result estimated by the supplementary information estimation unit 108, to compare the slot name of the intention estimation result “nearby facility search [facility type=NULL]” which is acquired by the intention estimation unit 106 (step ST110a). When the slot names match each other (YES in step ST110a), the slot value of the supplementary information is filled in a “NULL” value in the intention estimation result (step ST110b), whereas when the slot names do not match each other (NO in step ST110a), the intention estimation result “nearby facility search [facility type=NULL] ” which is acquired by the intention estimation unit 106 is sent to the command execution unit 110, just as it is. In the above-mentioned example, the slot name “facility type” of the supplementary information and the slot name of the imperfect intention match each other, and therefore the field is filled with the slot value and a perfect intention such as “nearby facility search [facility type=restaurant]” is acquired. This intention is sent to the command execution unit 110. Note that in step ST110b, the field may be filled with the slot value only when the score is equal to or greater than a preset threshold.

The command execution unit 110 executes a machine command corresponding to the intention supplemented by the intention supplementation unit 109 (step ST109). For example, the command execution unit 110 searches for nearby restaurants and displays a list of nearby restaurants. The response generation unit 111 then generates a synthetic voice corresponding to the machine command executed by the command execution unit 110 (step ST109). As the synthetic voice, for example, “Ruto shuuhen no resutoran wo kensaku shimashita, risuto kara eran de kudasai. (Restaurants in the surroundings of the route have been found; please select one from the list.)” is provided. The notification unit 112 notifies the user of the synthetic voice generated by the response generation unit 111 by using the speaker or the like. As a result, as shown in “S3” of FIG. 8, a notification such as “Ruto shuuhen no resutoran wo kensaku shimashita, risuto kara eran de kudasai. (Restaurants in the surroundings of the route have been found; please select one from the list.)” is provided for the user.

As mentioned above, according to Embodiment 1, the syntactic analysis unit 104 divides a complex sentence inputted thereto into plural simple sentences, the intention estimation is carried out on each of the simple sentences, and supplementary information is estimated from one of the simple sentences whose intention estimation has failed. Then, an intention included in one of the simple sentences from which an insufficient intention estimation result is provided is supplemented by using the supplementary information. By operating in this way, the user's intention can be estimated correctly.

Further, because the command execution unit 110 executes a corresponding machine command on the basis of the intention which is supplemented by the intention supplementation unit 109, the operation load on the user can be reduced. More specifically, the number of times that interaction is carried out can be reduced to be smaller than that in the case of using a conventional device.

Although in the explanation made above, the case in which the number of slots in each intention is one is shown in order to avoid complicatedness, an intention having plural slots can be handled by making a comparison between slot names. Further, when there are plural simple sentences whose intention estimation has failed, supplementary information having the highest score among the final scores acquired at the time of the estimation of supplementary information can be selected, and appropriate supplementary information can also be selected by making a comparison between slot names.

As previously explained, because the intention estimation device according to Embodiment 1 includes: the morphological analysis unit for carrying out a morphological analysis on a complex sentence including plural intentions; the syntactic analysis unit for carrying out a syntactic analysis on the complex sentence on which the morphological analysis is carried out by the morphological analysis unit, to divide the complex sentence into plural simple sentences; the intention estimation unit for estimating an intention included in each of the plural simple sentences; the supplementary information estimation unit for, when among the simple sentences which are estimation targets for the intention estimation unit, there is a simple sentence whose intention estimation has failed, estimating supplementary information from the simple sentence whose intention estimation has failed; and the intention supplementation unit for, when among the simple sentences which are the estimation targets for the intention estimation unit, there is a simple sentence from which an imperfect intention estimation result is provided, supplementing the imperfect intention estimation result by using the estimated supplementary information, a user's intention can also be estimated for a complex sentence including plural intentions with a high degree of accuracy.

Further, because the intention estimation device according to Embodiment 1 includes the supplementary information estimation model storage unit for holding a supplementary information estimation model showing a relation between simple sentences and pieces of supplementary information, and the supplementary information estimation unit estimates supplementary information by using the supplementary information estimation model, supplementary information can be estimated efficiently.

Further, because in the intention estimation device according to Embodiment 1, the supplementary information estimation model is configured such that a morpheme of each of the simple sentences is defined as a feature quantity, and this feature quantity is associated with a score for each of the pieces of supplementary information, and the supplementary information estimation unit determines, as to each of the pieces of supplementary information, scores of morphemes of the simple sentence whose intention estimation has failed, and estimates supplementary information on the basis of a final score which is acquired by calculating a product of the scores, supplementary information having a high degree of accuracy can be estimated.

Further, because in the intention estimation device according to Embodiment 1, the imperfect intention estimation result shows a state in which no slot value exists in a combination of a slot name and a slot value, and each of the pieces of supplementary information is expressed by a slot name and a slot value, and, when the estimated supplementary information has a slot name matching that of the imperfect intention estimation result, the intention supplementation unit sets a slot value of the estimated supplementary information as a slot value of the imperfect intention estimation result, the imperfect intention estimation result can be surely supplemented with an intention.

Further, because the intention estimation device according to Embodiment 1 includes the voice input unit for receiving an input of voice including plural intentions, and the voice recognition unit for recognizing voice data corresponding to the voice inputted to the voice input unit, to convert the voice data into text data about a complex sentence including the plural intentions, and the morphological analysis unit carries out a morphological analysis on the text data outputted from the voice recognition unit, a user's intention can also be estimated for the voice input with a high degree of accuracy.

Further, because the intention estimation method according to Embodiment 1 uses the intention estimation device according to Embodiment 1, to perform: the morphological analysis step of carrying out a morphological analysis on a complex sentence including plural intentions; the syntax analysis step of carrying out a syntactic analysis on the complex sentence on which the morphological analysis is carried out, to divide the complex sentence into plural simple sentences; the intention estimation step of estimating an intention included in each of the plural simple sentences; the supplementary information estimation step of, when among the simple sentences which are estimation targets for the intention estimation step, there is a simple sentence whose intention estimation has failed, estimating supplementary information from the simple sentence whose intention estimation has failed; and the intention supplementation step of, when among the simple sentences which are the estimation targets for the intention estimation step, there is a simple sentence from which an imperfect intention estimation result is provided, supplementing the imperfect intention estimation result by using the estimated supplementary information, a user's intention can also be estimated for a complex sentence including plural intentions with a high degree of accuracy.

### Embodiment 2

Embodiment 2 is an example of estimating a supplementary intention for an intention in which intention estimation has failed, by using a history of states which have been recorded in a device, an intention which has been estimated correctly, and the morphemes of a simple sentence whose intention estimation has failed.

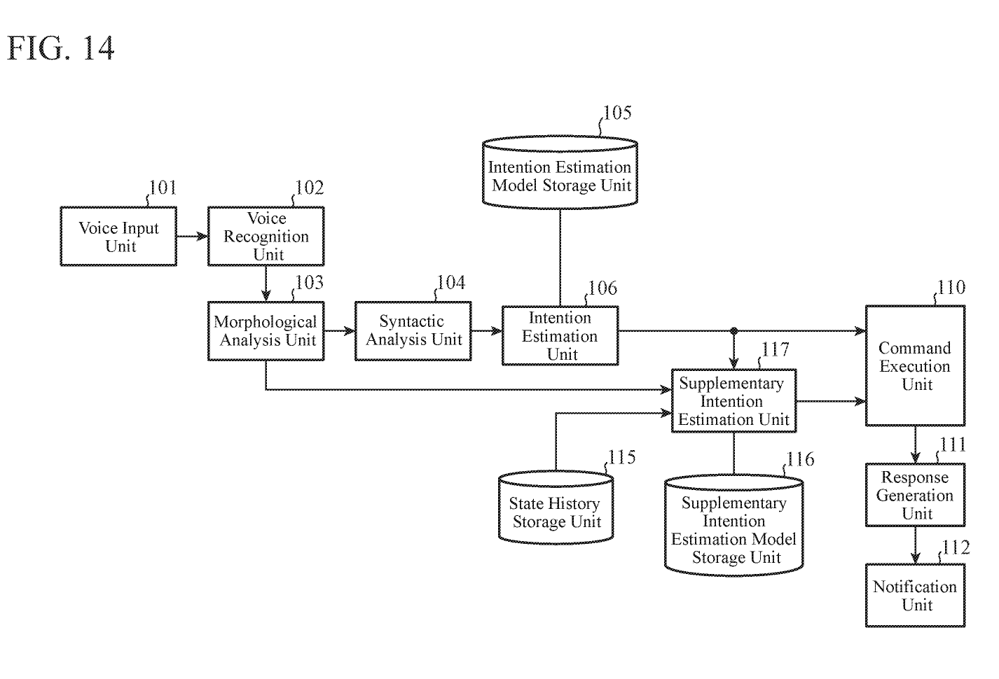

FIG. 14 is a block diagram showing an intention estimation device according to Embodiment 2. The intention estimation device according to Embodiment 2 includes a state history storage unit 115, a supplementary intention estimation model storage unit 116, and a supplementary intention estimation unit 117, instead of the supplementary information estimation model storage unit 107, the supplementary information estimation unit 108, and the intention supplementation unit 109 according to Embodiment 1. Because the other components are the same as those according to Embodiment 1 shown in FIG. 1, the corresponding components are denoted by the same reference numerals, and the explanation of the components will be omitted hereafter.

The state history storage unit 115 holds, as a state history, a current state of the intention estimation device, the current state being based on a history of intentions estimated until a current time. For example, in a case in which the intention estimation device is used to a car navigation system device, a route setting state such as “destination settings have already been done” or “with waypoint” is held as such a state history.

The supplementary intention estimation model storage unit 116 holds a supplementary intention estimation model which will be mentioned later. The supplementary intention estimation unit 117 is a processing unit that estimates a supplementary intention for a simple sentence whose intention estimation has failed while defining, as feature quantities, an intention estimation result of a simple sentence whose intention has been able to be estimated by an intention estimation unit 106, the morphemes of the simple sentence whose intention estimation has failed, and the state history stored in the state history storage unit 115.

Further, the hardware configuration of the intention estimation device according to Embodiment 2 is implemented by the configuration shown in FIG. 4 of Embodiment 1. Here, the state history storage unit 115 and the supplementary intention estimation model storage unit 116 are implemented on a storage device 160, and the supplementary intention estimation unit 117 is stored, as a program, in the storage device 160.

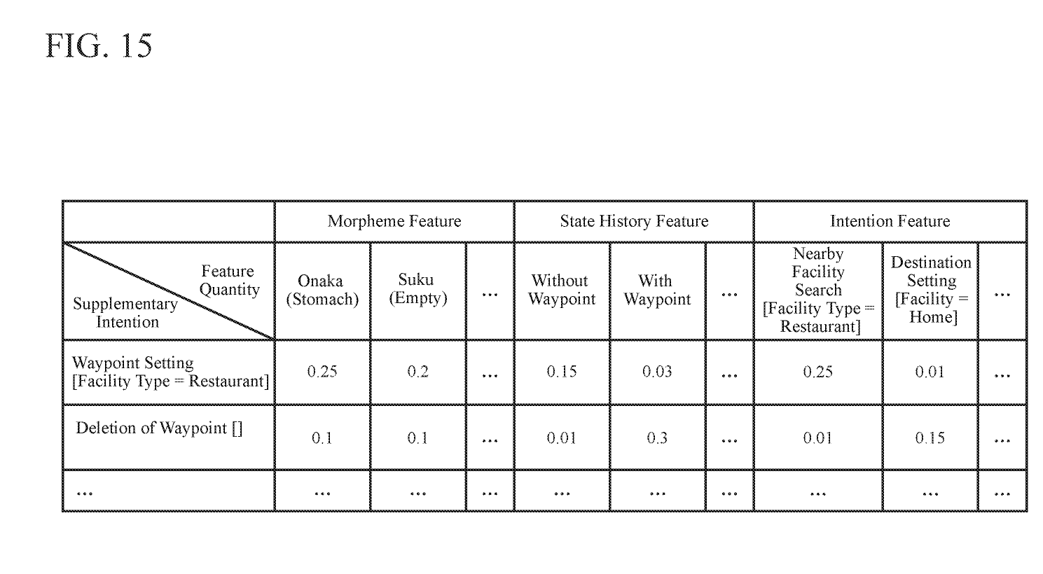

FIG. 15 is a diagram showing an example of the supplementary intention estimation model according to Embodiment 2. As illustrated in the figure, the supplementary intention estimation model includes data in which each of pieces of supplementary intention is associated with the scores of feature quantities which are included in plural morphemes of simple sentences, state history information, and intentions which can be estimated. In FIG. 15, “onaka (stomach)” and “suku (empty)” are morpheme features. “Without waypoint” and “With waypoint” are state history information features. “Nearby facility search [facility type=restaurant]” and “destination setting [facility=home]” are intention features. As shown in FIG. 15, because the morphemes “onaka (stomach)” and “suku (empty)” and the intention feature “nearby facility search [facility type=restaurant]” provide a high possibility that a search for restaurants will be made, the score of the supplementary intention “waypoint setting [facility type=restaurant]” is high. Further, because a waypoint setting may be made, the state information feature “without waypoint” has a higher score than “with waypoint.” In contrast, because “with waypoint” provides a high possibility that a supplementary intention “deletion of waypoint []” will be estimated, “with waypoint” has a higher score for the supplementary intention than “without waypoint.”

Next, the operation of the intention estimation device according to Embodiment 2 will be explained. First, processing for generating a supplementary intention estimation model will be explained.

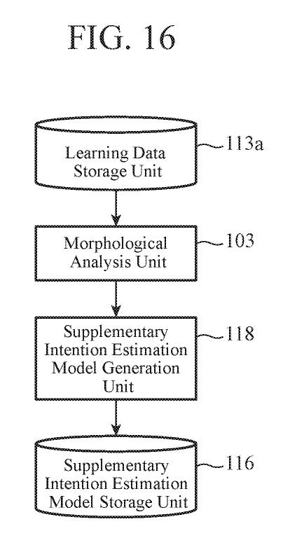

FIG. 16 is an explanatory drawing showing a configuration for explaining the processing for generating an intention supplementation model according to Embodiment 2. In FIG. 16, a learning data storage unit 113a stores learning data in the form of a correspondence of supplementary intention results with plural sentence examples, intentions, and pieces of state history information.

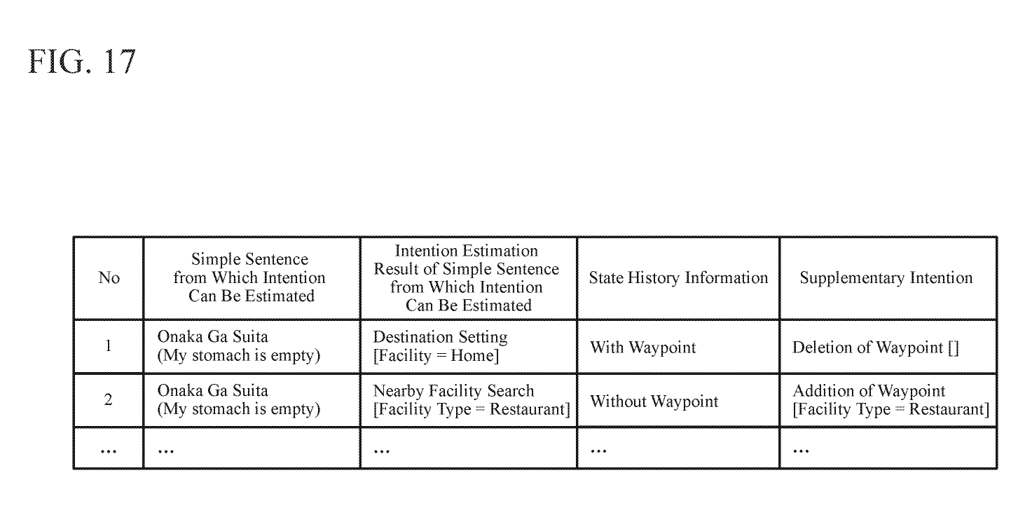

FIG. 17 is an explanatory drawing showing an example of the learning data for the supplementary intention estimation model according to Embodiment 2. As shown in FIG. 17, the learning data are data in which supplementary intention estimation results are provided for sentence examples of simple sentences each of whose intentions cannot be estimated, pieces of state history information, and intention estimation results. For example, the supplementary intention “deletion of waypoint []” is provided for the sentence example No.1 “Onaka ga suita (My stomach is empty)”, “destination setting [facility=home]”, and “with waypoint.” This supplementary intention is manually provided in advance.

Returning to FIG. 16, the supplementary intention estimation model generation unit 118 is a processing unit that learns the correspondence of the pieces of supplementary intention information, which is stored in the learning data storage unit 113a, by using a statistical method. The supplementary intention estimation model generation unit 118 generates a supplementary intention estimation model by using morphemes extracted by a morphological analysis unit 103, and the pieces of state history information and the supplementary intentions which are included in the learning data.

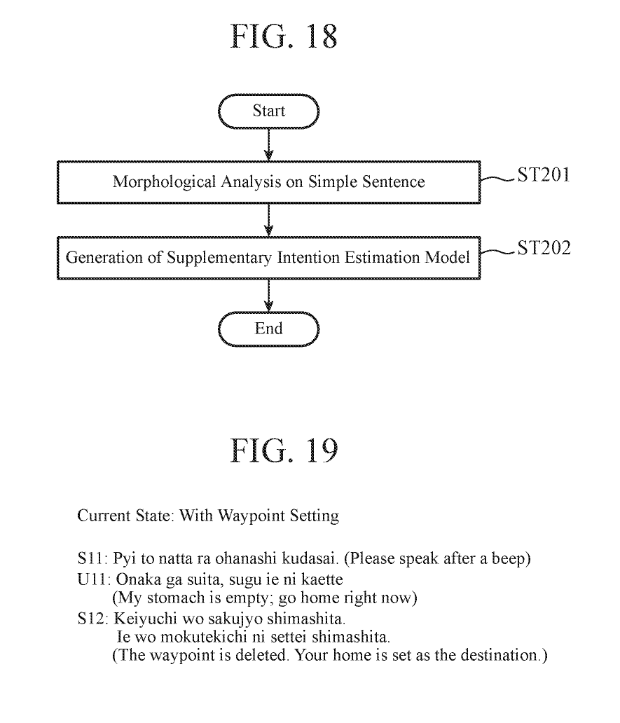

FIG. 18 is a flowchart for explaining the processing for generating a supplementary intention estimation model according to Embodiment 2. First, the morphological analysis unit 103 carries out a morphological analysis on each of the sentence examples of the learning data stored in the learning data storage unit 113a (step ST201). Because this morphological analysis is the same process as that in step ST1 of Embodiment 1, the explanation of the morphological analysis will be omitted hereafter.

The supplementary intention estimation model generation unit 118 combines the morphemes provided through the analysis by the morphological analysis unit 103, and the state history and the supplementary intentions which are set as the learning data, to generate a supplementary intention estimation model (step ST202). For example, in the case of the morphemes “onaka (stomach)” and “suku (empty)”, the supplementary intention estimation model generation unit 118 determines that scores are high because the supplementary intention included in the learning data, as shown in FIG. 17, “deletion of waypoint []”, in contrast to the intention estimation result “destination setting [facility=home]” of a simple sentence whose intention can be estimated and the state history information “with waypoint”.

The supplementary intention estimation model generation unit 118 performs the same processing as the above-mentioned processing on all the sentence examples, all the pieces of state history information, and all the intentions for learning, which are included in the learning data, to finally generate a supplementary intention estimation model as shown in FIG. 15.

Although in the explanation, an example of defining, as feature quantities, all the morphemes of a simple sentence whose intention estimation has failed, the state history recorded in the state history storage unit 115, and an intention estimation result of a simple sentence whose intention has been able to be estimated, and using the feature quantities for the estimation of a supplementary intention is shown, this embodiment is not limited to this example. Alternatively, a clear rule such as a rule “to use morphemes other than Japanese particles” or a rule “not to use intention features for a specific state history” can be determined to select feature quantities, or only morphemes having a good effect on the estimation of a supplementary intention can be used by using a statistical method.

Next, supplementary intention estimation processing using the supplementary intention estimation model will be explained.

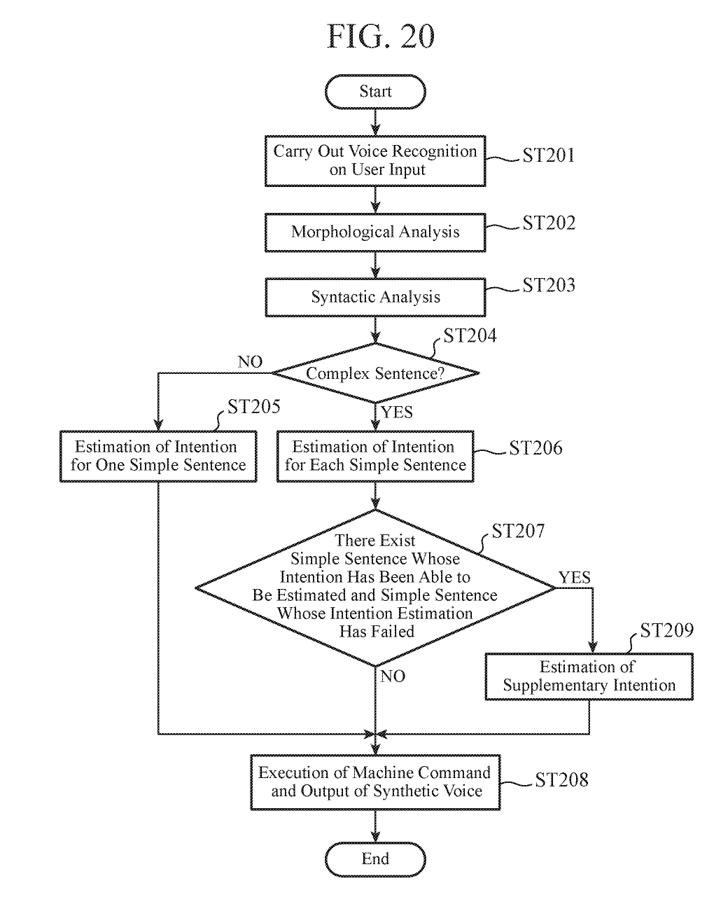

FIG. 19 is a diagram showing an example of interaction according to Embodiment 2. As shown in FIG. 19, it is assumed that information “with waypoint setting” is recorded in the state history storage unit 115. Hereafter, the supplementary intention estimation processing will be explained using a flow chart of FIG. 20.

As shown in FIG. 19, a notification unit 112 of the intention estimation device utters “Pyi to natta ra ohanashi kudasai (Please speak after a beep)” (S11). In response to this utterance, a user utters “Onaka ga suita, sugu ie ni kaette. (My stomach is empty; go home right now.)” (U11).

First, a voice recognition unit 102 performs a voice recognition process on the user input, to convert the user input into text data, and the morphological analysis unit 103 performs a morphological analysis process on the text data (steps ST201 and ST202). Next, a syntactic analysis unit 104 performs a syntactic analysis process on the text data (step ST203). At this time, the text data corresponding to the user input is divided into plural simple sentences such as a simple sentence 1 “Onaka ga suita (My stomach is empty)” and a simple sentence 2 “Sugu ie ni kaette (Go home right now).” The syntactic analysis unit 104 outputs the text data about each of the simple sentences, each of whose morphological analyses is performed, to the intention estimation unit 106, and processes of steps ST204 to ST206 are performed. Because processes of step ST205 and subsequent steps are the same as those of step ST105 and subsequent steps in Embodiment 1, the explanation of these processes will be omitted hereafter.

The intention estimation unit 106 performs an intention estimation process on each of the simple sentences 1 and 2 by using the intention estimation model (step ST206). In the above-mentioned example, the intention estimation unit 106 has been unable to estimate any intention for the simple sentence 1, but has estimated an intention “destination setting [facility=home]” for the simple sentence 2.

Because the results acquired by the intention estimation unit 106 show that the simple sentence whose intention estimation has failed and the simple sentence whose intention has been able to be estimated exist (YES step ST207), the processes of step ST209 and subsequent steps are performed. The supplementary intention estimation unit 117 uses, as feature quantities, the intention “destination setting [facility=home]” included in the simple sentence, the intention being estimated by the intention estimation unit 106, the morphemes “onaka (stomach)” “ga”, “suku (empty)”, and “ta” of the simple sentence whose intention has been unable to be estimated, the morphemes being acquired from the morphological analysis unit 103, and the state history “with waypoint” stored in the state history storage unit 115, to make a comparison with the supplementary intention estimation model and determine the scores of the feature quantities for each of the supplementary intentions (step ST209). The supplementary intention estimation unit 117 then calculates the product of the scores of the feature quantities for each of the supplementary intentions by using the computation expression shown in FIG. 11. More specifically, the supplementary intention estimation unit 117 estimates an appropriate supplementary intention on the basis of final scores each of which is acquired from the scores of the plural feature quantities.

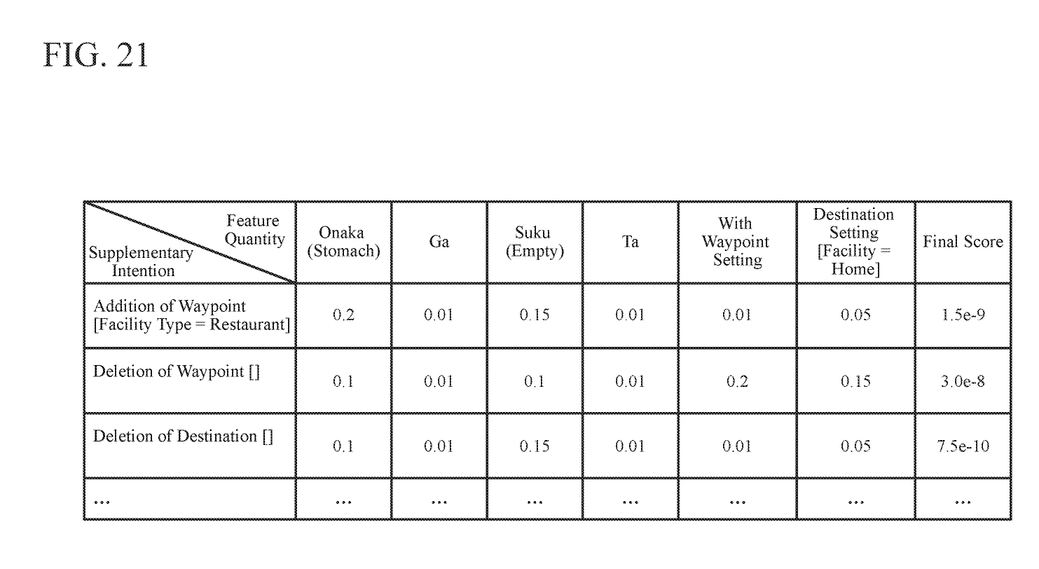

FIG. 21 is a diagram showing the final score acquired for each execution sequence according to Embodiment 2. In this example, because, for the supplementary intention “addition of waypoint [restaurant]”, a score of the feature quantity “onaka (stomach)” is 0.2, a score of the feature quantity “ga” is 0.01, a score of the feature quantity “suku (empty)” is 0.15, a score of the feature quantity “ta” is 0.01, a score of the state history feature “with waypoint” is 0.01, and a score of the intention feature “destination setting [facility=home]” is 0.05, the final score S which is the product of these scores is calculated as 1.5e-9. Also for any other supplementary intention, the final score is calculated in the same way.

The supplementary intention estimation unit 117 estimates, as an appropriate intention, the supplementary intention “deletion of waypoint []” having the highest score among the calculated final scores of the supplementary intentions each of which is an estimation target.

Returning to FIG. 20, on the basis of both intentions included in plural simple sentences, the intentions being estimated by the intention estimation unit 106, and plural intentions which have been estimated for plural simple sentences by the supplementary intention estimation unit 117, a command execution unit 110 executes a machine command corresponding to each of the plural intentions (step ST208).

In the above-mentioned example, the intention “destination setting [facility=home]” is estimated for the simple sentence 2 by the intention estimation unit 106. Further, the intention “deletion of waypoint []” is estimated for the simple sentence 1 by the supplementary intention estimation unit 117. Therefore, the command execution unit 110 executes a command to delete a waypoint and a command to set the user's home as the destination.

The response generation unit 111 generates a synthetic voice “Keiyuchi wo sakujyo shimashita. Ie wo mokutekichi ni settei shimashita. (The waypoint is deleted. The home is set as the destination.)” which corresponds to the machine commands executed by the command execution unit 110, and the synthetic voice is given to the user by the notification unit 112, as shown in S12 of FIG. 19 (step ST208).

As previously explained, because the intention estimation device according to Embodiment 2 includes: the morphological analysis unit for carrying out a morphological analysis on a complex sentence including plural intentions; the syntactic analysis unit for carrying out a syntactic analysis on the complex sentence on which the morphological analysis is carried out by the morphological analysis unit, to divide the complex sentence into plural simple sentences; the intention estimation unit for estimating an intention included in each of the plural simple sentences; and the supplementary intention estimation unit for, when among the simple sentences which are estimation targets for the intention estimation unit, there is a simple sentence whose intention estimation has failed, defining, as feature quantities, an intention estimation result of a simple sentence whose intention has been able to be estimated by the intention estimation unit, morphemes of the simple sentence whose intention estimation has failed, and a state history based on a history of intentions provided until a current time and showing a current state of the intention estimation device, and for carrying out the estimation of an supplementary intention on the simple sentence whose intention estimation has failed, a user's intention can also be estimated for a complex sentence including plural intentions with a high degree of accuracy.

Further, because the intention estimation device according to Embodiment 2 includes the state history storage unit for recording the state history, and the supplementary intention estimation unit carries out the estimation of a supplementary intention by using the state history stored in the state history storage unit, intention estimation which reflects the state history can be carried out.

Further, because the intention estimation device according to Embodiment 2 includes the supplementary intention estimation model storage unit for storing a supplementary intention estimation model in which morphemes of simple sentences each of whose intention estimations fails, intention estimation results of simple sentences each of whose intentions can be estimated, and the state history are defined as feature quantities, and each of the feature quantities is associated with a score for each of supplementary intentions, and the supplementary intention estimation unit carries out the estimation of a supplementary intention by using the supplementary intention estimation model, a supplementary intention having a high degree of accuracy can be estimated.

Further, because in the intention estimation device according to Embodiment 2, the supplementary intention estimation unit determines the scores of feature quantities corresponding to the simple sentence whose intention estimation has failed, and carries out the estimation of a supplementary intention on the simple sentence whose intention estimation has failed on the basis of a final score which is acquired by calculating a product of the scores, the estimation of a supplementary intention can be surely carried out on the simple sentence whose intention estimation has failed.

Further, because the intention estimation device according to Embodiment 2 uses the intention estimation device according to Embodiment 2, to perform: the morphological analysis step of carrying out a morphological analysis on a complex sentence including plural intentions; the syntax analysis step of carrying out a syntactic analysis on the complex sentence on which the morphological analysis is carried out, to divide the complex sentence into plural simple sentences; the intention estimation step of estimating an intention included in each of the plural simple sentences; and the supplementary intention estimation step of, when among the simple sentences which are estimation targets for the intention estimation step, there is a simple sentence whose intention estimation has failed, defining, as feature quantities, an intention estimation result of a simple sentence whose intention has been able to be estimated in the intention estimation step, the morphemes of the simple sentence whose intention estimation has failed, and a state history based on a history of intentions provided until a current time and showing a current state of the intention estimation device, and carrying out the estimation of an supplementary intention on the simple sentence whose intention estimation has failed, a user's intention can also be estimated for a complex sentence including plural intentions with a high degree of accuracy.

Although in Embodiments 1 and 2 the example in which a single device is implemented as the intention estimation device is explained, the embodiments are not limited to this example, and a part of the functions can be performed by another device. For example, a part of the functions can be performed by a server or the like which is disposed outside.

Further, although it is assumed in Embodiments 1 and 2 that the target language for which intention estimation is performed is expressed as Japanese, these embodiments can also be useful for many languages.

In addition, it is to be understood that an arbitrary combination of two or more of the embodiments can be made, various changes can be made in an arbitrary component according to any one of the embodiments, and an arbitrary component according to any one of the embodiments can be omitted within the scope of the invention.

### INDUSTRIAL APPLICABILITY

As mentioned above, the intention estimation device according to the present invention has a configuration for recognizing a text inputted using voice, a keyboard, or the like, estimating a user's intention, and performing an operation which the user intends to perform, the intention estimation device is suitable for use as a voice interface for a mobile phone, a navigation device, and so on.

### REFERENCE SIGNS LIST

101 voice input unit, 102 voice recognition unit, 103 morphological analysis unit, 104 syntactic analysis unit, 105 intention estimation model storage unit, 106 intention estimation unit, 107 supplementary information estimation model storage unit, 108 supplementary information estimation unit, 109 intention supplementation unit, 110 command execution unit, 111 response generation unit, 112 notification unit, 113 learning data storage unit, 114 supplementary information estimation model generation unit, 115 state history storage unit, 116 supplementary intention estimation model storage unit, and 117 supplementary intention estimation unit.

1-11. (canceled)

12. An intention estimation device comprising:
processing circuitry
to carry out a morphological analysis on a complex sentence including plural intentions,
to carry out a syntactic analysis on the complex sentence on which the morphological analysis is carried out, to divide the complex sentence into plural simple sentences,
to estimate an intention included in each of the plural simple sentences,
when among the simple sentences which are estimation targets, there is a simple sentence whose intention estimation has failed, to estimate supplementary information from the simple sentence whose intention estimation has failed, and
when among the simple sentences which are the estimation targets, there is a simple sentence from which an imperfect intention estimation result is provided, to supplement the imperfect intention estimation result by using the estimated supplementary information.

13. The intention estimation device according to claim 12, wherein the processing circuitry holds a supplementary information estimation model showing a relation between simple sentences and pieces of supplementary information,
wherein the processing circuitry estimates the supplementary information by using the supplementary information estimation model.

14. The intention estimation device according to claim 13, wherein the supplementary information estimation model is configured such that each morpheme of each of the simple sentences is defined as a feature quantity, and the feature quantity is associated with a score for each of the pieces of supplementary information, and
wherein the processing circuitry determines, as to each of the pieces of supplementary information, scores of morphemes of the simple sentence whose the intention estimation has failed, and estimates the supplementary information on a basis of a final score which is acquired by calculating a product of the scores.

15. The intention estimation device according to claim 13, wherein the imperfect intention estimation result is expressed as a state in which no slot value exists in a combination of a slot name and a slot value, and each of the pieces of supplementary information is expressed by a slot name and a slot value, and
wherein when the estimated supplementary information has a slot name matching that of the imperfect intention estimation result, the processing circuitry sets a slot value of the estimated supplementary information as a slot value of the imperfect intention estimation result.

16. An intention estimation device comprising:
processing circuitry
to carry out a morphological analysis on a complex sentence including plural intentions;
to carry out a syntactic analysis on the complex sentence on which the morphological analysis is carried out, to divide the complex sentence into plural simple sentences;
to estimate an intention included in each of the plural simple sentences; and
when among the simple sentences which are estimation targets, there is a simple sentence whose intention estimation has failed, to define, as feature quantities, an intention estimation result of a simple sentence whose intention has been able to be estimated, morphemes of the simple sentence whose intention estimation has failed, and a state history showing a current state of the intention estimation device based on a history of intentions provided until a current time and, and to carry out estimation of an supplementary intention on the simple sentence whose intention estimation has failed.

17. The intention estimation device according to claim 16, wherein the processing circuitry records the state history, and
wherein the processing circuitry carries out the estimation of a supplementary intention by using the stored state history.

18. The intention estimation device according to claim 16, wherein the processing circuitry stores a supplementary intention estimation model in which morphemes of simple sentences each of whose intention estimations fails, intention estimation results of simple sentences each of whose intentions can be estimated, and the state history are defined as feature quantities, and each of the feature quantities is associated with a score for each of supplementary intentions,
wherein the processing circuitry carries out the estimation of a supplementary intention by using the supplementary intention estimation model.

19. The intention estimation device according to claim 18, wherein the processing circuitry determines scores of feature quantities associated with the simple sentence whose intention estimation has failed, and carries out the estimation of a supplementary intention on the simple sentence whose intention estimation has failed on a basis of a final score which is acquired by calculating a product of the scores.

20. The intention estimation device according to claim 12,
wherein the processing circuitry receives an input of voice including plural intentions, and
the processing circuitry recognizes voice data corresponding to the inputted voice, to convert the voice data into text data about a complex sentence including the plural intentions,
wherein the processing circuitry carries out a morphological analysis on the outputted text data.

21. An intention estimation method using the intention estimation device according to claim 12, to perform:
carrying out a morphological analysis on a complex sentence including plural intentions;
carrying out a syntactic analysis on the complex sentence on which the morphological analysis is carried out, to divide the complex sentence into plural simple sentences;
estimating an intention included in each of the plural simple sentences;
when among the simple sentences which are estimation targets for the intention estimation step, there is a simple sentence whose intention estimation has failed, estimating supplementary information from the simple sentence whose intention estimation has failed; and
when among the simple sentences which are the estimation targets for the intention estimation step, there is a simple sentence from which an imperfect intention estimation result is provided, supplementing the imperfect intention estimation result by using the estimated supplementary information.

22. An intention estimation method using the intention estimation device according to claim 16, to perform:
carrying out a morphological analysis on a complex sentence including plural intentions;
carrying out a syntactic analysis on the complex sentence on which the morphological analysis is carried out, to divide the complex sentence into plural simple sentences;
estimating an intention included in each of the plural simple sentences; and
when among the simple sentences which are estimation targets for the intention estimation step, there is a simple sentence whose intention estimation has failed, defining, as feature quantities, an intention estimation result of a simple sentence whose intention has been able to be estimated in the intention estimation step, morphemes of the simple sentence whose intention estimation has failed, and a state history based on a history of intentions provided until a current time and showing a current state of the intention estimation device, and carrying out estimation of an supplementary intention on the simple sentence whose intention estimation has failed.
